(19) United States
(12) Patent Application Publication
(10) Pub. No.: US 2008/0222456 A1
(43) Pub. Date: Sep. 11, 2008

(54) Method and System for Implementing Dependency Aware First Failure Data Capture

(76) Inventor: Angela Richards Jones, Durham, NC (US)

Correspondence Address: DILLON & YUDELL LLP, 8911 N. CAPITAL OF TEXAS HWY., SUITE 2110, AUSTIN, TX, 78759, US

(21) Appl. No.: 11/681,911

(22) Filed: Mar. 5, 2007

(51) Int. Cl. G06F 11/34

(52) U.S. Cl. 714/45

(57) ABSTRACT

A method and system for implementing failure data capture in a system having multiple components and where the components have processing dependencies with respect to other of the components. Trace data is collected for a first of the components using failure data capture data tracing. In response to detecting a failure condition in the first component, and in response to further determining that the first component is operating in a fail dependency mode, a correlation database that correlates errors' failure conditions with one or more of the multiple components is accessed to determine whether the correlation database specifies a correlation between the failure condition and at least one of the multiple components. Responsive to the correlation table specifying a correlation between the failure condition and one or more of the components, fail messages are sent only to the components for which the correlation table specifies the correlation

### BACKGROUND OF THE INVENTION

1. Technical Field

The present invention relates generally to incorporating dependency awareness factors into first failure data capture data logging procedures. More specifically, the present invention relates to enabling a failing component to communicate to dependent components the need for additional logging for first failure data capture.

2. Description of the Related Art

First failure data capture (FFDC) is currently utilized in multi-component systems for error analysis. In response to a failure of one or more FFDC-enabled system components, trace information for the failed components are dumped to an FFDC trace log. Conventional FFDC allows for collection of trace data for multiple components to be correlatively processed to facilitate precise determination of the cause of the failure(s).

A problem with conventional FFDC is that trace information for multiple components is only obtained in response to the failure of the object components. Failures may often arise in a component due to effects from dependent components that have not actually failed. In such cases, valuable trace data from the dependency components is not collected.

It can therefore be appreciated that a need exists for a method, system, and computer program product for more comprehensively collecting FFDC trace data in response to component failures. The present invention addresses this and other needs unresolved by the prior art.

### SUMMARY OF THE INVENTION

A method and system for implementing failure data capture in a system having multiple components and where the components have processing dependencies with respect to other of the components are disclosed herein. Trace data is collected for a first of the components using failure data capture data tracing. In response to detecting a failure condition in the first component, and in response to further determining that the first component is operating in a fail dependency mode, a correlation database that correlates errors failure conditions with one or more of the multiple components is accessed to determine whether the correlation database specifies a correlation between the failure condition and at least one of the multiple components. Responsive to the correlation table specifying a correlation between the failure condition and one or more of the components, fail messages are sent only to the components for which the correlation table specifies the correlation.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1A is a high-level block diagram illustrating dependency relationships in a multi-component system;

FIG. 1B is a high-level block diagram depicting failure conditions that may arise in the multi-component system shown in FIG. 1A;

FIG. 2 is a high-level block diagram illustrating a multi-component, system having an FFDC trace data collection and error logging mechanism in accordance with the present invention; and

FIG. 3 is a high-level flow diagram depicting steps performed during FFDC error logging in accordance with the present invention.

### DETAILED DESCRIPTION OF ILLUSTRATIVE EMBODIMENT(S)

The present invention is directed to an improved method, system, and computer program for implementing first failure data capture (FFDC) in a data processing system having multiple components. As known in the art, FFDC provides an automated snapshot of the system environment when an unexpected internal error, warning, or other failure condition occurs in a multi-component system. This snapshot is utilized by system administration management personnel to provide a better understanding of the state of the system when the problem arose. As explained below in further detail with reference to the figures, the present invention provides a mechanism by which system component interdependency information is incorporated and utilized by FFDC.

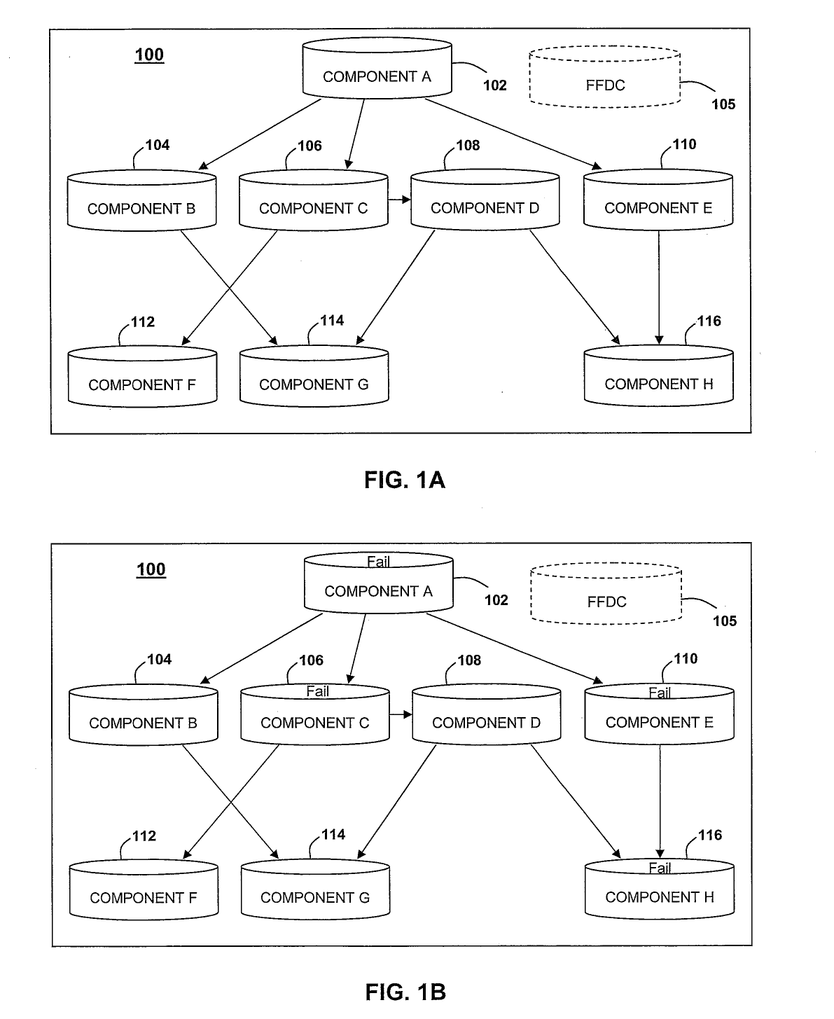

With reference now to the figures, wherein like reference numerals refer to like and corresponding parts throughout, and in particular with reference to FIG. 1A, there is depicted a high-level block diagram illustrating dependency relationships in a multi-component system such as may implement failure data capture in accordance with the invention. As shown in FIG. 1A, a system 100 generally comprises multiple hierarchically arranged components including a top-level component A 102. Dependencies between several of the depicted components such as between component A and several second tier components including component B 104, component C, 106, component D 108, and component E 110 are shown as directed line connectors. For example, component A 102 is shown as having a direct processing dependency relationship with components B 104, C 106, and E 110. Similarly, several dependencies between second tier components B 104, C 106, D 108, and E 110 and third tier components including component F 112, component G 114, and component H 116 are also shown in FIG. 1A. By virtue of intermediate dependencies and as illustrated by the connectors in the depicted embodiment, component A 102 further shares a dependency relationship with each of second tier component D 108 as well as third tier components F 112, G 114, and H 116. The processing dependencies referred to in the description and claims herein are generally characterized processing dependencies whereby one component (e.g. component A 102) utilizes processing output or information provided by another component (e.g. component C 106).

In one embodiment, system 100 may represent a server system such as the WebSphere Application Server system provided by IBM corporation. As further depicted in FIG. 1A, system 100 further includes a FFDC module 105, which in one embodiment comprises a script tangibly stored in data storage means within system 100. FFDC module 105 runs in the background and collects event and error data for events occurring for each of the depicted components during system runtime. The data collected by FFDC module 105 may be written to log files in a manner described in further detail below.

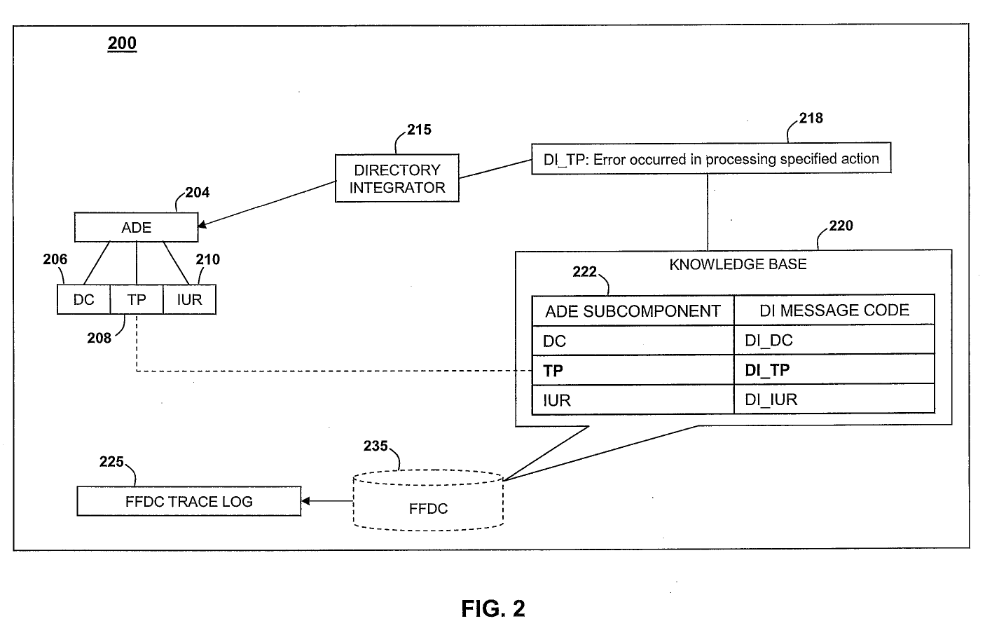

FFDC module 105 runs in the background until an event, such as a failed database command or module crash, occurs. When such an event transpires, FFDC module 105 automatically captures diagnostic information and records it in a designated file depicted in FIG. 2 as FFDC trace log file 225. This information contains crucial details that may help in the diagnosis and resolution of underlying system errors. Because this information is collected at the time an event occurs, the need to reproduce errors to obtain diagnostic information is reduced or eliminated. Examples of data types captured by FFDC module 105 include event diagnostic data and dump files containing process- or thread-specific data such as data specific to each of the components shown in FIGS. 1A and 1B where each of the components represents a processing thread.

Referring now to FIG. 1B, there is illustrated a high-level block diagram depicting failure conditions that may be detected in the multi-component system 100. As shown in FIG. 1B, a fail condition occurring in component A 102 may be related to or directly result from a failure occurring in other components having processing dependencies with component A. For example, the depicted fail condition of component A 102 may be related to a fail condition in component C 106 and/or the depicted fail conditions in component E 110. Similarly, the depicted fail condition in component E 110 may be related to or directly result from the depicted fail condition of component H 116. For conventional failure data capture processing, the depicted fail conditions may result in FFDC module 105 dumping the log files for all components for which a failure condition has been detected (i.e. component A 102 and components C 106, component E 110, and component H 116). While such multiple component trace dumps may be usefully processed in a correlative manner for failure analysis, this procedure fails to account for potentially useful trace data that has been collected but not dumped to the error analysis log file for the other mutually interdependent components that have not registered a failure condition.

The present invention improves upon and leverages extant FFDC techniques by including mechanisms for utilizing component dependency information for a failing component, such as component A 102, to decide which other components may have contributed to the failure. With reference to FIG. 2, there is depicted a high-level block diagram illustrating a multi-component system 200 having an FFDC trace data collection and error logging mechanism in accordance with the present invention. System 200 may include many system components simultaneously running and having various processing interdependencies. Included among such components is a directory integrator component 215 that has a processing dependency on another running process, namely, an autonomic deployment engine (ADE) component 204. Because of the processing dependency, a failure or other processing condition occurring in ADE component 204 may result in or contribute to a detected failure condition in directory integrator component 215. Likewise, a failure or other non-detected problematic conditions arising in any of dependency checker (DC) component 206, touchpoint (TP) component 208, and installable unit registry (IUR) component 210 may result in or contribute to a detected failure condition in ADE component 204 and/or directory integrator component 215.

To facilitate reliable and comprehensive FFDC failure analysis, system 200 further includes a FFDC module 235 that includes a knowledge base data structure 220 containing component interdependency and error mapping data. Namely, and as shown in FIG. 2, knowledge base 220 contains a data record 222 that is stored in data storage means such as a memory device and that records the components running in system 200 having a processing dependency relation with ADE component 204. Data record 222 contains row-wise data records each including one column-wise data field specifying each subcomponent on which ADE component 204 has a processing reliance. In the depicted embodiment, the three row-wise sub-records in data record 222 specify DC, TP, and IUR as the components on which ADE component 204 has a processing dependence. Each of the row-wise sub-records within data record 222 further includes a column-wise field specifying an error message code that is used in association with a failure occurring in the directory integrator component 215.

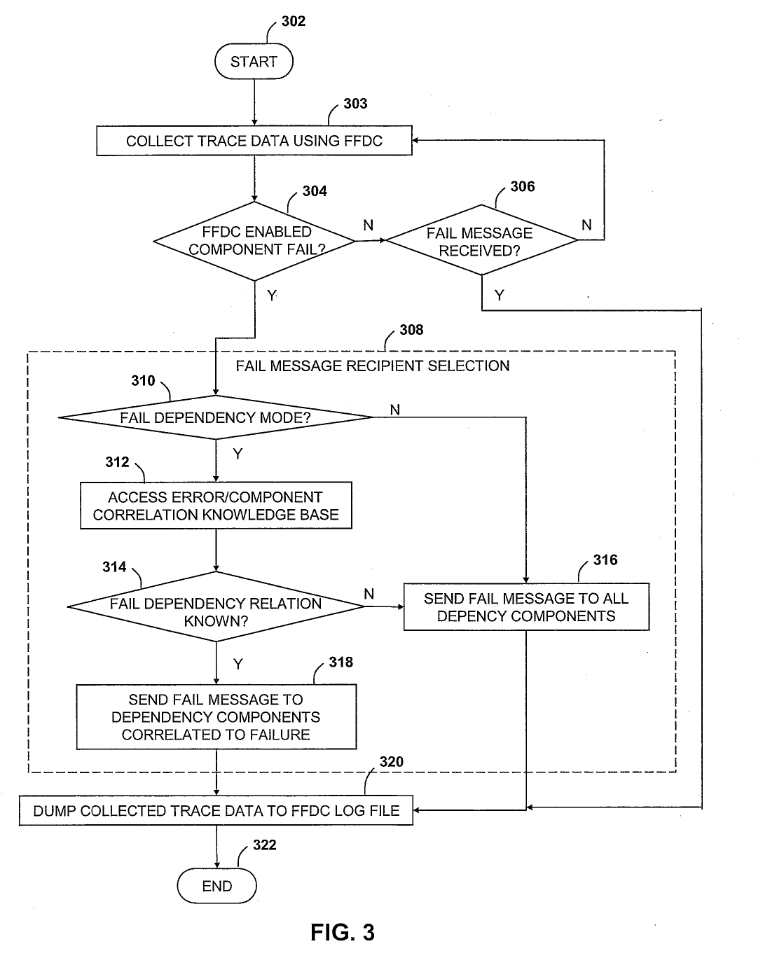

As explained in further detail below with reference to FIG. 3, the correlation of error failure conditions as specified by the stored error message codes with one or more components having dependency relations with a failed component can be used to determine which dependent components should log their respective trace data. In the embodiment shown in FIG. 2, a failure condition detected for directory integrator 215 is denoted by an error message 218 that specifies an error code DI_TP. FFDC module 235 utilizes the error code to locate one or more subcomponents having a processing dependency with the failed component 215. In this case, the error code DI_TP can be used to identify the TP component having a processing dependency with respect to ADE component 204 as possibly having a relation to the failure condition detected for directory integrator 215.

It should be noted that identification of dependent components in a system such as system 100 and 200 may be performed using alternative means to the knowledge base data structure 220 without departing from the spirit and scope of the present invention. For example, alternate embodiments may perform such dependency identification using tree-type rather than database type structures in which parent components having aggregate child components. In the depicted embodiment, ADE 204 uses extensible markup language (XML) files called “deployment descriptors” to illustrate such hierarchical parent child solutions which can in turn be used to identify component dependencies in a manner functionally analogous to the component dependency identification function provided by knowledge base 220.

FIG. 3 is a high-level flow diagram depicting steps performed during FFDC error logging in accordance with the present invention. The process begins as shown at steps 302 and 303 with a FFDC utility being used to collect trace data for each of the multiple components of the system in which at least some of the components have processing dependencies with respect to other components. Such trace data collection is preferably performed continuously as a background task as explained above with reference to systems 100 and 200 as long as no failure condition is detected and/or no fail message is received by the component in question as shown at steps 304, 306 and returning to step 303.

If a failure condition is detected for one of the components (step 304), the process commences with a fail message recipient selection step 308 now described in further detail. Specifically, a further determination is made as shown at step 310 of whether the system or the failed component is operating in a fail dependency FFDC mode. Such a mode setting may be a default setting in the FFDC configuration script or may be set by a system administrator as a flag that is read upon a failure condition detection. Continuing as illustrated at steps 316 and 320, if it is determined at step 310 that the failed component or the system is not operating in a fail dependency mode, a fail message is sent to all components identified as having a processing dependency with respect to the failing component. The processing dependency is preferably characterized as the failing component being dependent on one or more subcomponents running in the system. The identification of the components having a processing dependency may be performed by accessing a table such as within knowledge base 220 depicted in FIG. 2 that specifies the subcomponents on which the failed component depends. As shown at steps 306 and 320, the received error message(s) effectively instruct the identified components to dump trace data collected for each of the identified components in a FFDC trace log such as trace log 225 for failure analysis.

Returning to inquiry step 310, in response to determining that the failed component is operating in a fail dependency mode, a correlation database such as knowledge base 220 is accessed that correlates errors' failure conditions with one or more of the system components to determine whether the correlation database specifies a correlation between the failure condition detected at step 304 and at least one of the other components. Continuing as shown at steps 314 and 316, in response to the correlation table failing to specify a correlation between the failure condition and at least one of the other system components, fail messages are sent to all components identified as having a dependency relation with the failed component. If, however, the correlation table specifies a correlation between the failure condition and at least one of the other system components, a fail message that causes trace data of the respectively identified components to be dumped is sent only to the one or more components for which the correlation table specifies the correlation as illustrated at step 318. Following and in response to sending the fail message(s) only to the components for which the correlation table specifies the correlation, the failed component dumps its collected trace data to a log file for failure analysis. Furthermore, responsive to receiving the fail message(s) the respective recipient components dump their collected trace data to the failure analysis log file as shown at step 320 and the failure data capture process ends as shown at step 322.

While the invention has been particularly shown and described with reference to a preferred embodiment, it will be understood by those skilled in the art that various changes in form and detail may be made therein without departing from the spirit and scope of the invention. These alternate implementations all fall within the scope of the invention.

What is claimed is:

1. In a data processing system having multiple components in which at least some of the components have processing dependencies with respect to other of the components, a method for implementing failure data capture, said method comprising:
collecting trace data for a first of the components using failure data capture data tracing, wherein the first component has a processing dependency relationship with at least one other of the multiple components;
in response to detecting a failure condition in the first component:
determining whether the first component is operating in a fail dependency mode;
in response to determining that the first component is not operating in a fail dependency mode, sending a fail message to all of the at least one other of the multiple components having a dependency relationship with the first component, wherein receipt of a fail message by a component causes trace data collected for the component to be logged for failure analysis;
in response to determining that the first component is operating in a fail dependency mode:
accessing a correlation database that correlates errors' failure conditions with one or more of the multiple components to determine whether the correlation database specifies a correlation between the failure condition and at least one of the multiple components; and
in response to determining that the correlation table specifies a correlation between the failure condition and at least one of the multiple components, sending a fail message only to the at least one of the multiple components for which the correlation table specifies the correlation.

2. The method of claim 1, further comprising, following and in response to said sending a fail message only to the at least one of the multiple components for which the correlation table specifies the correlation, logging trace data collected for the first component.

3. The method of claim 1, wherein said failure data capture tracing comprises first failure data capture tracing.

4. In a data processing system having multiple components in which at least some of the components have processing dependencies with respect to other of the components, a system for implementing failure data capture, said system comprising:
means for collecting trace data for a first of the components using failure data capture data tracing, wherein the first component has a processing dependency relationship with at least one other of the multiple components;
means responsive to detecting a failure condition in the first component for:
determining whether the first component is operating in a fail dependency mode;
in response to determining that the first component is not operating in a fail dependency mode, sending a fail message to all of the at least one other of the multiple components having a dependency relationship with the first component, wherein receipt of a fail message by a component causes trace data collected for the component to be logged for failure analysis;
in response to determining that the first component is operating in a fail dependency mode:
accessing a component tree structure indicator that correlates errors' failure conditions with one or more of the multiple components to determine whether the correlation database specifies a correlation between the failure condition and at least one of the multiple components; and
in response to determining that the component tree structure indicator specifies a correlation between the failure condition and at least one of the multiple components, sending a fail message only to the at least one of the multiple components for which the component tree structure indicator specifies the correlation.

5. The system of claim 4, further comprising, means for logging trace data collected for the first component following and in response to said sending a fail message only to the at least one of the multiple components for which the component tree structure indicator specifies the correlation.

6. The system of claim 4, wherein said failure data capture tracing comprises first failure data capture tracing.
